(19) United States
(12) Patent Application Publication
(10) Pub. No.: US 2018/0154375 A1
(43) Pub. Date: Jun. 7, 2018

(54) Cyclone separator

(71) Applicant: Holcim Technology Ltd., Jona (CH)

(72) Inventor: Thomas LAMARE, Holderbank (CH)

(21) Appl. No.: 15/579,819

(22) PCT Filed: May 30, 2016
(86) PCT No.: PCT/IB2016/000734

§ 371 Date: Dec. 5, 2017

(30) Foreign Application Priority Data
Jun. 5, 2015 (AT) A 351/2015

(51) Int. Cl. B04C 5/103; B04C 5/04; B04C 5/13

(52) U.S. Cl. CPC B04C 5/103; B04C 5/13; B04C 5/04

(57) ABSTRACT

A cyclone separator for use in a cement production plant, includes a cylindrical upper section and a conical lower section. The cylindrical upper section includes a tangential inlet, an upper cover wall and a centrally arranged dip tube that axially traverses the cover wall and projects into the cylindrical section. The conical lower section includes a cone wall conically tapering to a lower outlet that is arranged coaxially with the dip tube. At least one longitudinal baffle is arranged in the cyclone separator to extend in an axial direction from the dip tube to the cone wall.

The invention refers to a cyclone separator for use in a cement production plant, comprising a cylindrical upper section and a conical lower section, wherein said cylindrical upper section comprises a tangential inlet, an upper cover wall and a centrally arranged dip tube axially traversing the cover wall and projecting into the cylindrical section, and wherein said conical lower section comprises a cone wall conically tapering to a lower outlet that is arranged coaxially with the dip tube.

A key component in clinker and cement production is the cyclone separator. It is used as cross-flow heat exchanger in suspension preheaters or as a particle separation device in raw mills, cement mills and dedusting applications. A cyclone is a vessel having a conical section. A dust-bearing gas-stream is fed into the cyclone tangentially, which produces an outer vortex within the vessel. The outer vortex is a high speed flow of gas rotating in a helical pattern from the top of the cyclone along the conically tapering section to the narrow end region at the bottom of the cyclone. There, the gas produces an inner vortex, which is a helical gas stream flowing upwardly and leaving the cyclone through the dip tube arranged at the top of the cyclone. The inner vortex is arranged within the outer vortex and coaxially with the latter.

The separation of particles from the gas stream is achieved as follows. Heavier particles in the rotating stream have too much inertia to follow the tight curve of the outer vortex and are collected at the cyclone wall, where they fall down and leave the cyclone via the lower outlet opening. In a conical system, as the outer vortex approaches the narrow end of the cyclone, the rotational radius of the stream is reduced, thus separating smaller and smaller particles. The cyclone geometry, together with flow rate, defines the cut point of the cyclone.

The number of cyclone stages used in gas-suspension preheaters varies from one to six. In raw mills or cooler dedusting applications, cyclones are generally used in pairs. Energy, in the form of fan-power, is required to draw the gas through the cyclones. The fan-power required to draw the gases through the string of cyclones is essentially proportional to the accumulated pressure drop occurring in the cyclone separators. Therefore, a reduction of the pressure drop occurring in each cyclone separator would be desirable in order to reduce the fan power needed for drawing the gas through a string with a set number of cyclone separators or to increase the number of cyclone separators in a string of cyclones without increasing the required fan power.

Existing cyclone modifications aiming at a reduction of the pressure drop generally change the shape of the cyclone inlet and outlet or sometimes insert vanes in the outlet, such as systems installed as an extension to the dip tube (Hurrivane® manufactured by A TEC). These solutions imply major modifications of the cyclone geometry at a significant cost.

Therefore, it is a purpose of this invention to reduce the pressure drop in cyclone separators with minimal structural modifications and at low cost.

To solve these and other objectives, the invention is characterized in that at least one longitudinal baffle is arranged in the cyclone separator to extend in an axial direction from the dip tube to the cone wall. Thus, the invention consists in inserting a vertical baffle between the dip tube of the cyclone separator and the cone wall, precisely in the area of high tangential velocities at the interface between the inlet and outlet vortices. While high tangential velocities at the cyclone wall are required to reach high separation efficiency, the highest tangential velocity are found close to the core at the interface between the inlet vortex (going downward) and the outlet vortex (going upward). The invention reduces only these core interface tangential velocities where a lot of kinetic energy is dissipated, thus reducing the overall pressure drop in the cyclone. The cyclone separation efficiency is not impacted since the invention only changes the core velocities and not the cyclone walls tangential velocities where the dust separation occurs.

Installing a baffle between the dip tube and the cone wall is a relatively simple and fast procedure, thereby minimizing costs and the time of interruption of the operation of the preheater. In particular, the baffle may be inserted into the cyclone separator either through the lower outlet opening or through the dip tube.

The baffle is arranged in the cyclone in an axial direction so that it may be exactly aligned at the interface between the outer vortex and the inner vortex. In this way, the efficiency of the baffle is maximized.

Preferably, a first free end of the baffle is connected to the dip tube and a second free end of the baffle is connected to the cone wall. The mounting of the baffle to the dip tube and to the cone wall may be achieved by conventional mounting techniques such as by bolting. Preferably, the baffle is connected to the dip tube and/or to the cone wall by welding.

According to a particularly preferred embodiment of the invention, the first free end of the baffle is connected to the dip tube so as to essentially by aligned with a cylindrical wall of the dip tube.

The baffle of the invention has a longitudinal extension that essentially corresponds to the distance between the lower rim of the dip tube and the cone wall. In particular, the baffle consists of a rod.

The rod may have a circular, oval or rectangular cross section.

The function of the baffle is to obstruct the helical flow of the gas in the region between the outer and the inner vortex, where the tangential velocity has a maximum, without impairing the separating function of the cyclone. In this connection tests have shown that best results can be achieved, if the baffle, in particular the rod, has a diameter measured in the radial direction, that corresponds to 3-5% of the diameter of the cylindrical section of the cyclone separator.

Further, the baffle, in particular the rod, preferably has an extension measured in the tangential direction, that does not exceed 5% of the diameter of the cylindrical section of the cyclone separator.

In order to safeguard uniform flow characteristics, a preferred embodiment of the invention provides that the baffle, in particular the rod, has the same diameter, measured in the radial direction, over its entire length.

Although a single baffle is sufficient to significantly reduce the pressure drop in a cyclone separator, certain embodiments of the invention may provide for more than one baffle. In particular, at least two baffles, preferably multiple baffles are arranged in the cyclone separator, each extending in an axial direction from the dip tube to the cone wall. Preferably, the at least two baffles are arranged at an equal distance from the axis of the cyclone separator. Thus, the at least two baffles are arranged along a virtual circle that is coaxial with the dip tube and the lower outlet opening. Preferably, the at least two baffles, in particular the multiple baffles are uniformly distributed along said circle.

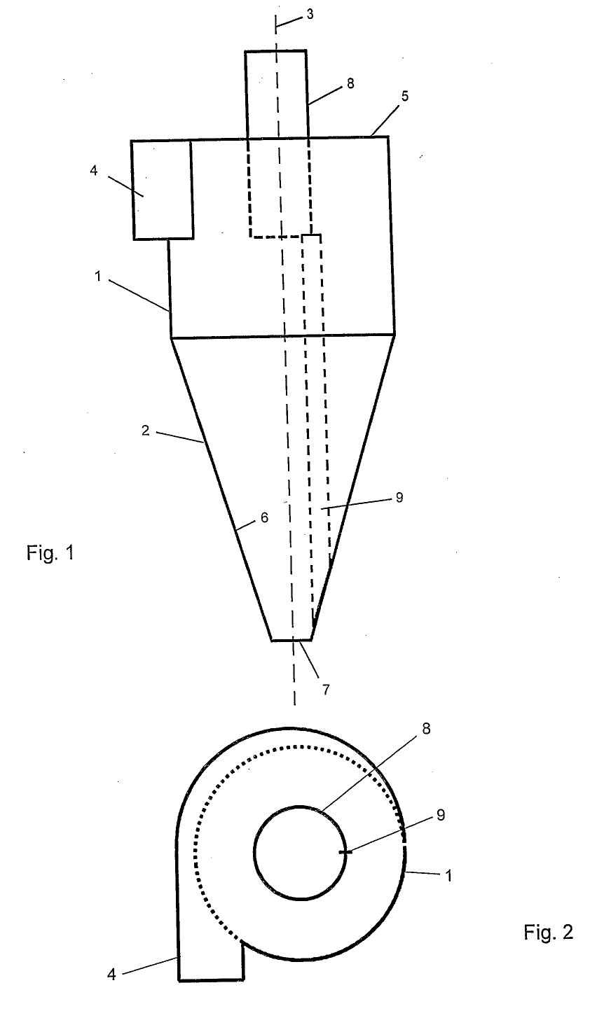

The invention will now be described with reference to an exemplary embodiment shown in FIG. 1 and FIG. 2. FIG. 1 shows a cyclone separator in a side view and FIG. 2 shows the cyclone separator of FIG. 1 in a top view.

In FIG. 1 a cyclone separator is schematically illustrated comprising a cylindrical upper section 1 and a conical lower section 2 being arranged coaxial with regard to axis 3. The cylindrical upper section 1 comprises a tangential inlet 4, through which a particles-bearing gas-stream is introduced tangentially into the cylindrical upper section 1. The cylindrical upper section 1 is closed by an upper cover wall 5. Upon entry into the cyclone the particles-bearing gas-stream travels downward along a helical path thereby forming an outer vortex. The particles contained in the gas stream are forced outwardly to the wall of the cyclone, in particular to the cone wall 6 of the conical lower section 2. The particles fall down along the cone wall 6 and leave the cyclone via the lower outlet 7. The gas turns upwards forming an inner vortex, the diameter of which substantially corresponds to the diameter of the dip tube 8, which is arranged to penetrate through the cover wall 5 into the cylindrical upper section 1 of the cyclone. The gas leaves the cyclone via the dip tube 8, which is arranged coaxially with the lower outlet 7.

According to the invention, a baffle 9, in particular a baffle rod is arranged in the cyclone to extend in an axial direction from the dip tube 8 to the cone wall 6.

In the top view according to FIG. 2 the tangential inlet 4 can be seen in more detail as well as the arrangement of the baffle 9.

1. A cyclone separator configured for use in a cement production plant, comprising a cylindrical upper section and a conical lower section, wherein the cylindrical upper section comprises a tangential inlet, an upper cover wall and a centrally arranged dip tube axially traversing the cover wall and projecting into the cylindrical section, and wherein the said conical lower section comprises a cone wall conically tapering to a lower outlet that is arranged coaxially with the dip tube, wherein at least one longitudinal baffle is arranged in the cyclone separator to extend in an axial direction from the dip tube to the cone wall.

2. A cyclone separator according to claim 1, wherein a first free end of the longitudinal baffle is connected to the dip tube and a second free end of the longitudinal baffle is connected to the cone wall.

3. A cyclone separator according to claim 2, wherein the dip tube has a cylindrical wall, and the first free end of the longitudinal baffle is connected to the dip tube so as to essentially be aligned with a cylindrical wall of the dip tube.

4. A cyclone separator according to claim 1, wherein the longitudinal baffle is connected to the dip tube and/or to the cone wall by welding.

5. A cyclone separator according to claim 1, wherein the longitudinal baffle consists of a rod.

6. A cyclone separator according to claim 5, wherein the rod has a circular, oval or rectangular cross section.

7. A cyclone separator according to claim 1, wherein the longitudinal baffle has a diameter measured in the radial direction that corresponds to 3-5% of the diameter of the cylindrical section of the cyclone separator.

8. A cyclone separator according to claim 1, wherein the longitudinal baffle has the same diameter, measured in the radial direction, over its entire length.

9. A cyclone separator according to claim 1, wherein at least two longitudinal baffles are arranged in the cyclone separator, each extending in an axial direction from the dip tube to the cone wall.

10. A cyclone separator according to claim 9, wherein the at least two longitudinal baffles are arranged at an equal distance from the axis of the cyclone separator.

11. A cyclone separator according to claim 1, wherein the dip tube has a cylindrical wall; the longitudinal baffle comprises a rod having a diameter, measured in the radial direction, that corresponds to 3-5% of the diameter of the cylindrical section of the cyclone separator; the longitudinal baffle has the same diameter, measured in the radial direction, over its entire length; the longitudinal baffle has a first free end connected to the dip tube so as to be essentially aligned with the cylindrical wall of the dip tube and the longitudinal baffle has a second free end connected to the cone wall; and the connection of the longitudinal baffle is by welding to the cylindrical wall of the dip tube and/or by welding to the cone wall.
